(19) United States
(12) Patent Application Publication
(10) Pub. No.: US 2009/0096430 A1
(43) Pub. Date: Apr. 16, 2009

(54) CHARGING AND RECHARGABLE DEVICES

(75) Inventors: Benjamin Luke Van Der Linde, Narre Warren South (AU); David Leigh Scrimshaw, Beaumaris (AU); Paul Davies, Belgrave (AU); Paul Miller, Upwey (AU); Paul Francis Connor, Elwood (AU)

Correspondence Address: AKERMAN SENTERFITT, P.O. BOX 3188, WEST PALM BEACH, FL, 33402-3188, US

(73) Assignee: Demain Technology Pty Ltd., Braeside (AU)

(21) Appl. No.: 12/258,944

(22) Filed: Oct. 27, 2008

Related U.S. Application Data
(63) Continuation-in-part of application No. PCT/AU2007/000536, filed on Apr. 26, 2007.

(30) Foreign Application Priority Data
Apr. 26, 2006 (AU) AU 2006902155

(51) Int. Cl. H02J 7/00

(52) U.S. Cl. 320/166

(57) ABSTRACT

A capacitor-based (supercapacitor, ultracapictor or psudeocapcitor) electrical charger, rechargeable device and energy storage pack for use with a rechargeable power tool. The rechargeable device includes a storage capacitor. The electrical charger includes a supply capacitor electrically connected to an electrical contact, the supply capacitor being charged when the electrical charger is connected to a power source. While in use, any charge in the supply capacitor is rapidly distributed between the supply capacitor and the storage capacitor when the rechargeable device is mounted in the receiver of the electrical charger. The electrical charger includes a safety interlock switch which only supplies power to the electrical contact of the charger after electrical terminal of the rechargeable device have engaged the electrical contact.

### CROSS REFERENCE TO RELATED APPLICATIONS

This application is a continuation-in-part application of PCT Application No. PCT/AU2007/000536, filed Apr. 26, 2007, which claims priority to AU 2006902155, filed Apr. 26, 2006, both of which are incorporated herein by reference in their entirety.

### FIELD OF THE INVENTION

The present invention generally relates to rechargeable devices which can be recharged using a charger and/or chargers thereof. In an exemplary application, the invention relates to a rechargeable power tool having a capacitor, including but not limited to a supercapacitor, ultracapacitor or pseudocapacitor, power storage means and a charger thereof and it will be convenient to hereinafter disclose the invention in relation to that exemplary application. However, it is to be appreciated that the invention is not limited to that application.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Supercapacitors, ultracapacitors and pseudocapacitors are forms of capacitor that are capable of storing a large amount of energy in the form of a static charge. They include electric double-layer capacitors and electrochemical double layer capacitors (EDLC). Supercapacitors, ultracapacitors and pseudocapacitors have a high energy density when compared to common capacitors.

A hybrid capacitor has relatively high capacitance and energy storage capabilities similar to supercapacitors, ultracapacitors and pseudocapacitors. A hybrid capacitor may include a metal anode and a pseudocapacitor cathode. Examples of such metals which form the anode include tantalum, niobium, aluminum, and zirconium. The cathode may be a porous metal oxide film typically used in pseudocapacitors in order to provide a relatively large capacitance. Examples of such metals used in the hybrid capacitor which form the cathode include ruthenium, iridium, nickel, rhodium, platinum, palladium, and osmium. The hybrid capacitor is advantageous in that it incorporates the high power density characteristics of supercapacitors, ultracapacitors and pseudocapacitors with the high energy density characteristics normally associated with electrochemical cells. As used herein, a hybrid capacitor may include any form of hybrid cell combining capacitor technology with any other form of energy storage technology.

For the purpose of describing this invention, the terms capacitor and ultracapacitor will hereinafter be used interchangeably. However, it is to be appreciated that reference hereinafter to a capacitor, capacitors, ultracapacitor or ultracapacitors is intended as a reference to any one or more of the group including supercapacitors, ultracapacitors, pseudocapacitors and hybrid capacitors and any other form of hybrid cell combining capacitor technology with any other form of energy storage technology.

Capacitors can be used as an alternative rechargeable device to electrochemical batteries. As power storage means, capacitors are capable of absorbing energy at a rapid rate in comparison to a normal electrochemical type battery and also discharge this stored energy at a rapid rate.

While it is possible to charge a capacitor relatively quickly, in some cases to full capacity in less than 10 seconds, most existing types of chargers are not able to provide such a rapid charge. The charge transferred is limited by the current or charge transfer rate of the power source. Most existing chargers charge the power storage means of a rechargeable device using a low current that provides a so-called electrical trickle charge, taking several minutes to hours to reach full charge capacity.

Moreover, if a fast charge is achieved, a high current is typically used. When a high current is used in a circuit, it is desirable to have good electrical contact between all components in the charging circuit. If the contact between any two components is less than ideal, a high current can potentially cause arcing between these components, result in a high temperature between the components, possibly damaging the components, charger and/or capacitor. The risk of a user being electrocuted can also increase if there is poor contact between two components conducting a high current.

In most cases, the rechargeable device (including the capacitor,) is separable from the charger to enable portability. The rechargeable device must therefore be inserted into the charging circuit to be recharged. This typically involves abutting the charge input terminals of the rechargeable device with charge output terminals of the charger.

It would therefore be desirable to provide a rechargeable device and/or charger which allows for fast charging of a power storage means such as a capacitor. Preferably, the charging arrangement would be configured to ensure that there is good contact between the terminals of rechargeable device and charger.

### SUMMARY OF THE INVENTION

According to one aspect of the present invention, there is provided an electrical charger for charging a rechargeable electrical device, the rechargeable electrical device including at least one storage ultracapacitor, the charger including:

a receiver for receiving the rechargeable electrical device;

at least one electrical contact through which power can be supplied to the rechargeable electrical device, the electrical contacts being arranged to engage corresponding electrical terminals of the rechargeable electrical device when the rechargeable electrical device is mounted to the receiver; and

at least one supply ultracapacitor electrically connected to the at least one electrical contact, the supply ultracapacitor being charged when the electrical charger is connected to a power source;

wherein, in use, any charge in the supply ultracapacitor is rapidly distributed between the supply ultracapacitor and storage ultracapacitor when the rechargeable electrical device is mounted to the receiver thereby providing a rapid charge to the rechargeable electrical device.

Accordingly, the provision of the supply ultracapacitor in the charger allows the storage ultracapacitor to be rapidly charged by the charger. The supply ultracapacitor is charged by a charging power supply such as a battery, mains power supply or power device linked to the mains power supply. The supply ultracapacitor can therefore be left to charge in the charger, preferably to full capacity and thereafter, once the rechargeable electrical device is connected to the charger, the supply ultracapacitor can rapidly transfer the charge stored therein between the supply ultracapacitor and storage ultracapacitor.

As can be appreciated, the amount of charge transferred to the storage ultracapacitor is dependent on the relative capacities of the supply ultracapacitor and the storage ultracapacitor. While the relative energy capacity of the supply ultracapacitor and the storage ultracapacitor could be any ratio, it is preferable that the energy capacity of the supply ultracapacitor to be more than half the energy capacity of the storage ultracapacitor. More preferably, the energy capacity of the supply ultracapacitor is greater than the energy capacity of the storage ultracapacitor.

For example, in one embodiment, the ratio of the energy capacity of the supply ultracapacitor to the energy capacity of the storage ultracapacitor can be selected to be between 50% to 200%. In this embodiment, a power source such as mains power or a battery is continuously charging the supply ultracapacitor. When the rechargeable electrical device is inserted into the charger, the energy will rapidly (in some cases almost instantly) even out between the supply ultracapacitor and the storage ultracapacitor resulting in the storage ultracapacitor being charged to between ⅓ (corresponding to the 50% ratio) to ⅔ (corresponding to the 200% ratio) of the storage ultracapacitors maximum charge capacity. Further charging is preferably accomplished using the power source such as a battery, mains power or the like which supplies an electrical trickle charge. In effect, the power source takes over charging the rechargeable electrical device, preferably over a brief period of time. The advantage of this system is that the charger can provide an instant charge to the rechargeable electrical device, preferably greater than 50% charge capacity of the rechargeable electrical device. This instant charge allows a user to go and work again while the supply ultracapacitor is recharged. A user can then use the charger to top up the charge in the storage ultracapacitor of the rechargeable electrical device.

Nevertheless, the greater the energy capacity of the supply ultracapacitor compared to the storage ultracapacitor, the more charge that is transferred to the storage ultracapacitor when each ultracapacitor is connected during charging. It is therefore preferable for the energy capacity of the supply ultracapacitor to be more than twice the energy capacity of the storage ultracapacitor. This results in the rechargeable electrical device being more rapidly charged to full capacity.

As can be appreciated, if the charger did not include a supply ultracapacitor, the storage ultracapacitor would be charged using a conventional power supply such as a battery, mains supply or the like, and charge the storage ultracapacitor with purely a trickle charge. Charging of the storage ultracapacitor using this type of charger may be slower than a charger which included a supply ultracapacitor.

In order to maintain good electrical contact between the electrical terminals of the rechargeable electrical device and the electrical contacts of the charger, it is preferable that the charger further includes a switch for controlling the supply of power to the at least one electrical contact. In one form, the switch is arranged to be actuated to supply power to the at least one electrical contact after the electrical terminals engage the at least one electrical contact and to be actuated to terminate supply of power to the at least one electrical contact before the electrical terminals disengage from the at least one electrical contact.

In another form, the switch is actuable relative to an activated position, the activated position corresponding to when power is supplied to the at least one electrical contact, wherein the switch is actuated to the activated position when the rechargeable electrical device is mounted to the receiver and is actuated from the activated position when the rechargeable electrical device is dismounted from the receiver.

In this embodiment of the invention, the interrelationship between the switch and the at least one electrical contact ensures that good contact is maintained between the electrical terminals of the rechargeable electrical device and the at least one electrical contact of the charger at all times during charging of the rechargeable electrical device. Moreover, such an arrangement ensures that power supply to the at least one electrical contact is terminated before the electrical terminals of the rechargeable electrical device are separated from the at least one electrical contacts of the charger. When high current is used, this arrangement substantially obviates the occurrence of arcing, heat build up or the like should the rechargeable electrical device be removed from charger during the charging process. As can be appreciated, such an arrangement could be used in many forms of chargers.

In another form, the rechargeable electrical device has a base to which are mounted the electrical terminals, the base being adapted to actuate the switch to the activated position when the rechargeable electrical device is mounted to the receiver. In another form the switch is actuated by hand. In another form, the switch is an electronic switch and actuation of the switch is caused electronically. The switch may incorporate a laser beam that is tripped when the rechargeable

electrical device is mounted to the receiver, whereby tripping of the laser beam causes actuation of the switch to the activated position.

Preferably, the receiver includes a recess into which the rechargeable electrical device is insertable and the at least one electrical contact is situated at a base of the recess. The receiver may include a recess into which the rechargeable electrical device is insertable and the at least one electrical contact and the switch may be situated at a base of the recess.

In another form, the receiver may include a plug to which the rechargeable electrical device is mountable and the at least one electrical contact is situated on the plug. The plug may include a means for engaging and retaining the rechargeable electrical device mounted to the plug and the at least one electrical contact and the switch may be situated on the plug. A flexible electrically conductive lead may connect the at least one electrical contact situated on the plug with the supply capacitor.

The at least one supply ultracapacitor and the at least one storage ultracapacitor includes any one or more of the group including ultracapacitors, supercapacitors, pseudocapacitors and hybrid capacitors.

According to another aspect of the present invention, there is provided an electrical charger for charging a rechargeable device including at least one storage ultracapacitor for storing power, the electrical charger including:

a receiver to which the rechargeable device is mountable;

at least one electrical contact through which power can be supplied to the rechargeable device, the electrical contact being arranged to engage a corresponding electrical terminal of the rechargeable device when the rechargeable device is mounted to the receiver; and

a switch for controlling a supply of power to the at least one electrical contact, the switch being engaged and actuated by the rechargeable device when the device is mounted or dismounted from the receiver;

wherein the switch is arranged with the receiver to be actuated to supply power to the at least one electrical contact after the electrical terminal of the rechargeable device has engaged the at least one electrical contact and to be actuated to terminate supply of power to the at least one electrical contact before the electrical terminal of the rechargeable device has disengaged from the at least one electrical contact.

It is possible that the rechargeable device may move when mounted to the receiver. It is therefore preferable for the at least one electrical contact and the corresponding electrical terminal of the rechargeable device to be movable relative to each other while in engagement.

In one form, the at least one electrical contact includes a pair of opposing electrodes that define a gap for receiving, in an interference fit, the corresponding electrical terminal of the rechargeable device therebetween. The at least one electrical contact is movable relative to the receiver while maintaining contact with the corresponding electrical terminal of the rechargeable device. The at least one electrical contact may also be spring loaded.

In one form, the switch is actuable relative to an activated position, the activated position corresponding to when power is supplied to the at least one electrical contact, wherein the switch is actuated to the activated position when the rechargeable device is mounted to the receiver and is actuated from the activated position when the rechargeable device is dismounted from the receiver

When the switch comprises a pivot type switch, the activated position could correspond to the switch being moved to one side of the pivot. For a rolling or rotating type switch, the activated position could correspond to the switch being rotated in one direction. In a preferred embodiment, the switch is a depressible switch.

The electrical terminals of the rechargeable device and the at least one electrical contact of the charger are located on each of the respective components in positions which allow abutting engagement of the electrical terminals and at least one electrical contact. The electrical terminals of the rechargeable device may be located on or at a base of the rechargeable device. However, as can be appreciated other embodiments of the charger are possible with the terminals located in other positions on the screwdriver.

In one form, the receiver includes a recess into which the rechargeable device is insertable and the at least one electrical contact is situated at a base of the recess. The switch may be situated at the base of the recess.

In another form, the receiver includes plug to which the rechargeable device is mountable and the at least one electrical contact is situated on the plug. The plug may include means for engaging and retaining the rechargeable device mounted to the plug and the switch may be situated on the plug. Also, a flexible electrically conductive lead may connect the at least one electrical contact with the charger. Power may be supplied to the at least one electrical contact through the lead.

The receiver may have a plurality of electrical contacts and the electrical device a corresponding number of terminals. Each electrical contact is arranged with the receiver at two spaced apart locations. In one preferred form of the present invention, the charger includes two spring loaded contacts located on the receiver. In embodiments where the receiver includes a recess, the switch may be located in the recess at a relatively lower location thereby ensuring the contacts are compressed before the switch can be activated. Consequently, should the rechargeable device be removed from the charger, such a switch will move from the activated position and turn off the charger while the spring loaded contacts still apply enough force to make good contact with the terminals of the power supply device.

It is preferable for the rechargeable device be secured or otherwise fastened to or within the receiver in order to ensure good contact between the electrical terminals of the rechargeable device and the electrical contacts of the charger during the duration of the charging process. The charger therefore preferably includes a latching system or a fastening arrangement for fastening the rechargeable device to the receiver when the rechargeable device is mounted to the receiver. This ensures a good and secure contact is created between the rechargeable device and the charger.

The fastening arrangement can take any suitable form, mechanical, electrical, magnetic, adhesive or the like. The fastening arrangement may include a movable projection member that engages with a recess in a housing structure housing the rechargeable device. More preferably, the fastening arrangement includes a movable projection member that engages a portion of a housing structure housing the rechargeable device. In an alternate embodiment, the fastening arrangement includes a bayonet type fitting which interengages with a corresponding arrangement on or associated with the rechargeable device.

Provision of a large current in a charger can also require the use of large electrical components. Some embodiments of the charger include suitably large electrical components. Other embodiments include components which control the transfer of energy and current from the charger to the rechargeable device.

The rechargeable device can include a variety of different power storage means for storing power. In most embodiments of the present invention, the rechargeable device is configured to be rapidly charged. Accordingly, the power storage means of the rechargeable device includes at least one supply ultracapacitor electrically connected to the at least one electrical contact, the supply ultracapacitor being charged when the electrical charger is connected to a power source. The supply ultracapacitor allows for fast charging of the rechargeable device. The rechargeable device could include an energy storage pack for use with a powered device such as a powered tool in the form of a sander, power screwdriver, power drill, power saw, chainsaw, planer, router, grinder, polisher, rotary tool, light, powered knife or any other powered tool with which the rechargeable device could be suitable for use. The powered device may include other forms of portable powered devices such as audio and/or visual devices, computers, telephones or any other portable powered device with which the rechargeable device could be suitable for use. The rechargeable device could include any one the abovementioned devices themselves. It will be appreciated that the rechargeable device may take other suitable forms and have other suitable applications.

In those embodiments, configured for a rapid charge, it is preferable that the charger includes at least one supply ultracapacitor in order to enable fast transfer of electricity or power between the charger and the rechargeable device. If the rechargeable device also includes a storage ultracapacitor, the charger could then charge the rechargeable device as previously described.

The receiver is typically a framework, receptacle, bracket or portion of the charger to which the rechargeable device is mounted. The receiver preferably has a configuration or shape which mutually cooperates and corresponds with the configuration and/or shape of the rechargeable device and/or the structure in which it is mounted or any part thereof. In one form, the receiver includes a recess into which the rechargeable device is insertable. The configuration of the recess is arranged to cooperate with the shape of the rechargeable device and/or the structure in which it is mounted therein. The at least one electrical contact and/or the switch may be situated at a base of the recess.

In another form, the receiver includes plug to which the rechargeable device is mountable and the at least one electrical contact is situated on the plug. The plug may include means for engaging and retaining the rechargeable device mounted to the plug and the switch may be situated on the plug. The electrical charger may further include a flexible electrically conductive lead connecting the at least one electrical contact with the charger and through which power is supplied to the at least one electrical contact.

The at least one storage ultracapacitor and the at least one supply ultracapacitor includes any one or more of the group including supercapacitors, ultracapacitors, pseudocapacitors and hybrid capacitors.

According to yet another aspect of the present invention there is provided a rechargeable power tool capable of being rapidly charged by a charger, the rechargeable power tool including:

a housing;

an operative portion, movable relative to the housing;

a drive means including a motor being operable to move the operative portion relative to the housing;

at least one ultracapacitor power storage means for powering the drive means;

one or more electrical terminals electrically connected to the ultracapacitor arranged to engage corresponding electrical contacts of a electrical charger for charging the ultracapacitor; and

wherein the ultracapacitor power storage means alone powers the drive means.

The at least one ultracapacitor includes any one or more of the group including super-capacitors, ultracapacitors, pseudo-capacitors and hybrid capacitors.

The rechargeable power tool according to the present invention can include a number existing arrangements of rechargeable power tools including but not limited to sanders, power screwdrivers, power drills, power saws, chainsaws, planers, routers, lathes, grinders, polishers, rotary tools, or the like.

The rechargeable power tool may be an electromechanical appliance such as a kitchen, household or personal care electrical appliance.

The operative portion of the power tool is arranged to accommodate the particular movable element and movement required for that tool. For example in a power saw, the operative portion includes a fastening system for fastening a saw blade. In a circular saw, the fastening system is rotatable about an operative axis. In a jigsaw the fastening system is configured to allow a reciprocal axial movement about an operative axis. In other power tools, such as for example a power drill, power screwdriver, or other rotary tools, the operative portion includes a fastening assembly for holding an operative element which is rotatable about an operative axis by the drive means. In these embodiments, the fastening system can be a chuck or collet. Preferably, the power tool further includes a gearing arrangement between the drive means and the operative portion.

In a further aspect, the present invention provides a rechargeable energy storage pack for use with an electrically powered device, the rechargeable energy storage pack including a housing adapted to couple with an electrically powered device and with an electrical charger; one or more electrical terminals arranged to engage a corresponding electrical contact of an electrical charger and a corresponding electrical contact of the device; and an ultracapacitor disposed within the housing and coupled to the one or more electrical terminals, whereby the ultracapacitor is charged by power received from the electrical charger and the device receives the power from the ultracapacitor through the one or more electrical terminals.

It is preferable that the rechargeable power tool according to the present invention is adapted to be charged using an electrical charger according to the present invention.

### BRIEF DESCRIPTION OF THE DRAWINGS

The present invention will now be described with reference to the figures of the accompanying drawings, which illustrate particular preferred embodiments of the present invention, wherein:

FIG. 1 is an isometric view of a portable screwdriver incorporating a rechargeable device and an electrical charger thereof incorporating one preferred embodiment of the present invention. The screwdriver is shown remote from the charger.

FIG. 2 is an isometric view of the portable screwdriver and electrical charger shown in FIG. 1. The screwdriver is shown mounted in the electrical charger.

FIG. 3 is a cross-sectional front view of the portable screwdriver shown in FIG. 1 illustrating the internal components of the screwdriver.

FIG. 4 is a cross-sectional front view of the charger shown in FIG. 1 illustrating the internal components of the charger.

FIG. 5 is a detailed view of the highlighted section D of FIG. 3.

FIG. 6 is a cross-sectional front view of another form of the charger shown in FIG. 1 having slightly different internal components of the charger shown in FIG. 3.

FIG. 7 is a cross-sectional front view of the electrical charger with the portable screwdriver mounted therein shown in FIG. 2.

FIG. 8 is a detailed view of the highlighted section B of FIG. 7.

FIG. 9 is a detailed view of another form of the fastener latch in another embodiment of the charger incorporating one preferred embodiment of the present invention.

FIG. 10 is an isometric view of a portable screwdriver having a rechargeable device and an electrical charger thereof incorporating another preferred embodiment of the present invention.

FIG. 11 is an isometric view of the portable screwdriver and electrical charger shown in FIG. 10. The screwdriver is shown mounted to the electrical charger.

FIG. 12 is a cross-sectional front view of the portable screwdriver and electrical charger shown in FIG. 10 illustrating the internal components of the screwdriver and the electrical charger.

FIG. 13 is a cross-sectional side view of the portable screwdriver and electrical charger shown in FIG. 10 illustrating the internal components of the screwdriver and the electrical charger.

FIG. 14 bottom view of the portable screwdriver shown in FIG. 10.

FIG. 15 top view of the portable electrical charger shown in FIG. 10.

FIG. 16 is a cross-sectional side view of the electrical charger shown in FIG. 10 illustrating the internal components of the electrical charger.

FIG. 17 is a cross-sectional front view of the electrical charger shown in FIG. 10 illustrating the internal components of the electrical charger.

FIG. 18 is a detailed view of the highlighted section G of FIG. 12.

FIG. 19 is a cross-sectional front view of a portable screwdriver having a rechargeable device and an electrical charger thereof, similar to the embodiment of FIG. 10, but incorporating an alternative form of the switch for controlling a supply of power to the at least one electrical contact.

FIG. 20 is a cross-sectional front view of the portable screwdriver, rechargeable device and electrical charger of FIG. 19 in which the screwdriver is in the process of being mounted to the electrical charger and the electrical contacts of the portable screwdriver are in engagement with the corresponding electrical terminals of the rechargeable device.

FIG. 21 is a cross-sectional front view of the portable screwdriver, rechargeable device and electrical charger of FIG. 19 in which the screwdriver is in the mounted to the electrical charger and the switch is actuated to the activated position while the electrical contacts of the portable screwdriver are in engagement with the corresponding electrical terminals of the rechargeable device.

FIG. 22 is a cross-sectional front view of a portable screwdriver having a rechargeable device and an electrical charger thereof, similar to the embodiments of FIGS. 10 and 19, but without the fastening arrangement for fastening the rechargeable device in position mounted to the receiver.

FIG. 23 is a cross-sectional front view of the portable screwdriver, rechargeable device and electrical charger of FIG. 22 in which the screwdriver is in the process of being mounted to the electrical charger and the electrical contacts of the portable screwdriver are in engagement with the corresponding electrical terminals of the rechargeable device.

FIG. 24 is a cross-sectional front view of the portable screwdriver, rechargeable device and electrical charger of FIG. 22 in which the screwdriver is in the mounted to the electrical charger and the switch is actuated to the activated position while the electrical contacts of the portable screwdriver are in engagement with the corresponding electrical terminals of the rechargeable device.

### DETAILED DESCRIPTION

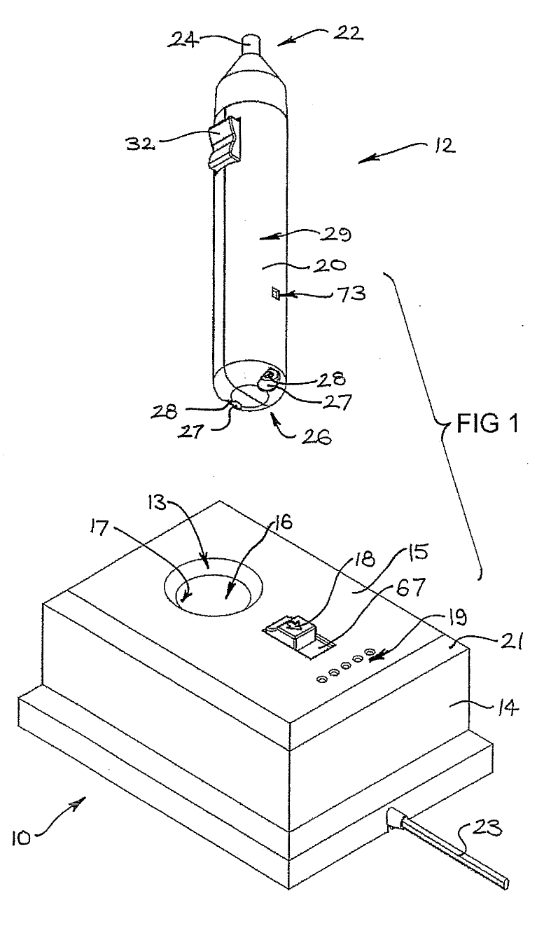

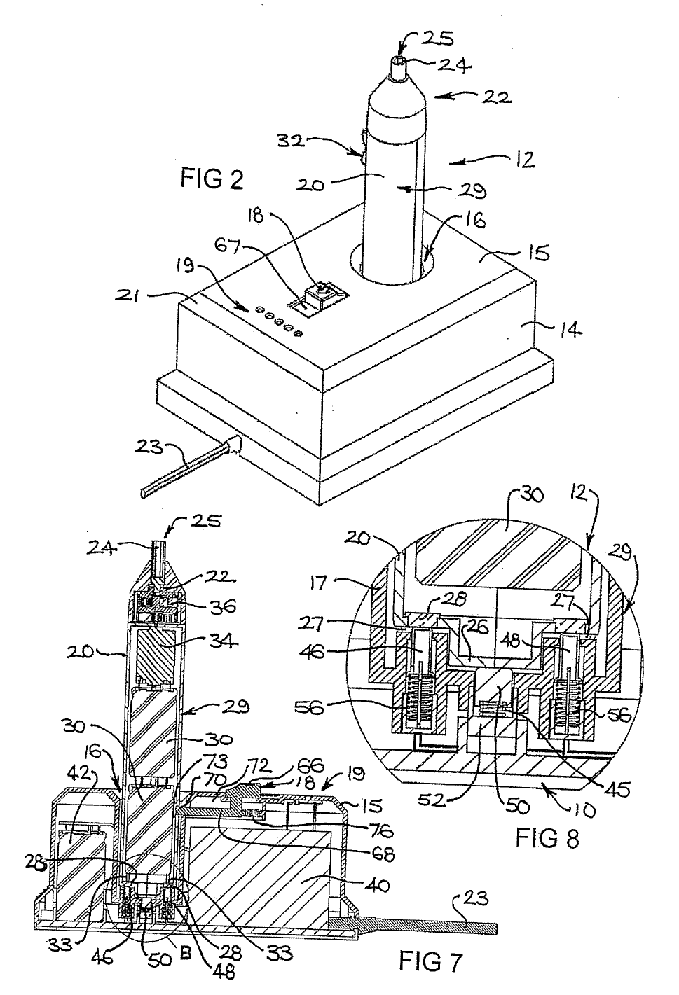

Referring to FIGS. 1 and 2, there is shown an electrical charger 10 for charging a rechargeable device, in this case a rechargeable electric screwdriver 12. The illustrated charger 10 consists of a generally rectangular box housing 14 having an upper surface 15 (relative to the orientation shown in FIGS. 1 and 2) which includes an opening 13 for a cylindrically shaped support recess 16. The walls 17 of the support recess 16 form a receiver into which the rechargeable electric screwdriver 12 is received for charging as shown in FIG. 2. The upper surface 15 also includes a locking or fastener latch 18, which is longitudinally movable relative to the face of the upper surface 15 of the charger 10.

In addition, a set of five indicator lights 19, typically LED type lights, are provided on the upper surface 15 between an edge 21 and the fastener latch 18. When the indicator lights 19 are illuminated, they provide an indication of the charging level or capacity of the power storage means within the screwdriver 12 when the screwdriver 12 is mounted in the support recess 16. For example, in one embodiment of the charger 10 when the screwdriver 12 has no charge, the indicator lights 19 are all coloured red. As the screwdriver 12 is charged, the indicator lights 19 accordingly change from red to green. A mains power cord 23 enters the housing 14 of the charger 10 from one side of the charger 10. Other indication means are also possible such as needle deflection, LCD display, audible or the like which could provide an equivalent function.

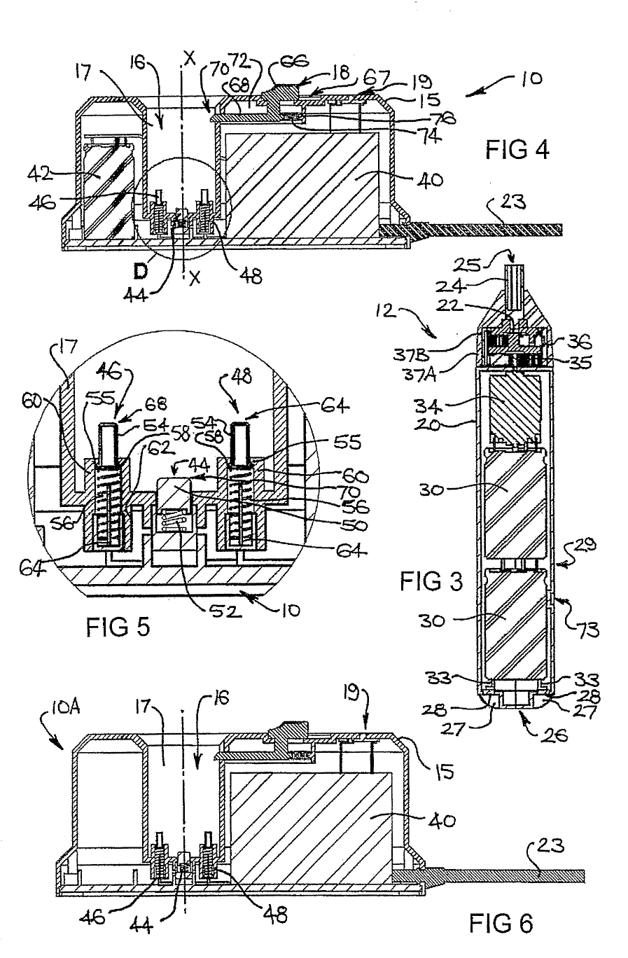

Still referring to FIGS. 1 and 2, it can be seen that the electric screwdriver 12 consists of a generally cylindrical housing 20 having a frustoconical top operative end 22 capped with a output shaft 24. The output shaft 24 defines a hexagonal shaped cavity 25 (as best seen in FIG. 2) into which a tool piece (not illustrated) such as a screwdriver head or drill bit having a corresponding shaped hexagonal shaft can be friction fitted. Operation of the screwdriver 12 rotates the output shaft 24 and fitted tool piece. The cylindrical housing 20 also includes a generally domed shape base 26 which includes two spaced apart circular recesses 27 which enclose two electrical terminals 28. The electrical terminals 28 connect to a power storage means, being in the illustrated embodiment two capacitors 30 (as best shown in FIGS. 3 and 7). The body of the housing 20 includes an operative pivot switch 32 which when depressed operates the screwdriver 12, causing the output shaft 24 to rotate.

FIG. 3 shows a cross-sectional view of the electric screwdriver 12 illustrating the internal components of the screwdriver 12 enclosed within the housing 20. Starting at the base of the screwdriver 12, it can be observed that the electrical terminals 28 on the exterior of the base 26 are connect to the two cylindrical storage capacitors 30 via two connecting links 33. The two capacitors 30 are connected in series and are vertically stacked within the housing 20 of the screwdriver 12. Although the capacitors 30 are connected in series in the illustrated embodiment, it is to be appreciated that the capacitors 30 could be connected in parallel or in a combination of series and parallel. Also, there may be any number of capacitors 30 including the illustrated two capacitors 30 or even one capacitor 30 or three capacitors 30 or more.

An electric motor 34 is positioned axially above the two capacitors 30. As can be appreciated, the capacitors 30 provide power to operate the motor 34. Control of the electricity from the capacitors 30 to the motor 34 is controlled by switch 32 (best seen in FIGS. 1 and 2). Switch 32 also regulates the amount of power being supplied to the motor 34 and thereby controls the speed of the motor 34.

An armature 35 of the motor 34 is connected to a gearing assembly 36 consisting of two interconnected geared wheels 37A and 37B having a gear ratio of between 1:1 to 1:100, preferably 1:35 between rotation of the armature 35 and rotation of the output shaft 24. The gearing assembly 36 is rotatably connected to the output shaft 24. The output shaft 24 is thereby rotated by operation of the motor 34 when the switch 32 is actuated.

The internal componentry of one form of the charger 10 incorporating the present invention is illustrated in FIG. 4. The charger 10 includes a power transformer 40, switch mode power supply or other power transformation components/units which converts the 240V AC power from the mains (via power cord 23) to 6 volt AC power which is subsequently rectified to DC for use in the charger 10. Other arrangements are also possible such as conversion from 120V AC to 6V AC which is subsequently rectified or the like. The transformer 40 is connected to a supply capacitor 42 enclosed within the housing 14. In the illustrated embodiment, the supply capacitor 42 has twice the capacitance of the combined capacitance of the two storage capacitors 30 contained in the screwdriver 12. It should be appreciated however, that the supply capacitor 42 could have any capacitance from 1% to more than 300% the capacitance of the storage capacitors 30. The electrical output of the supply capacitor 42 is connected to a depression switch 44 located in the support recess 16 of the charger 10, which is inturn connected to two spring mounted contact rods 46 and 48. Each of the depression switch 44 and spring mounted contact rods 46 and 48 are movable or depressible along the direction of vertical axis X-X of the support recess 16. While a switch in the form of the depression switch 44 is illustrated, it is to be appreciated that any other suitable form of switch may be implemented.

The configuration of depression switch 44 and spring mounted contact rods 46 and 48 are best illustrated in the magnified view shown in FIG. 5. As illustrated, the depression switch 44 consists of a cylindrical button 50 mounted on a helical spring 52 which biases the button 50 towards a raised condition, as shown in FIG. 5. When in the raised condition, the switch 44 is in an off position and does not supply electrical power from the supply capacitor 42 to the contact rods 46 and 48. However, when the button 50 is depressed, placing the button 50 in a depressed condition and compressing spring 52, as shown best in FIG. 8, the switch is placed in an activated or “on” condition and allows power to be supplied from the supply capacitor 42 to the contact rods 46 and 48. In the embodiment illustrated in FIGS. 2 to 8, the button 50 is housed in a bore hole 45 located at the centre of the base 62 of the support recess 16. It is to be appreciated, however, that other forms of the switch 44 could involve a button 50 located in any other suitable location such as to one lateral side. The button 50 includes a bead or rib (not illustrated) which interlocks with a groove (not illustrated) in the bore hole 45 wall so as to prevent the button from falling out of the bore hole 45 when the charger 10 is moved, tipped or the like.

Each of the spring mounted contact rods 46 and 48 comprise a generally cylindrical conductive metal cap 54, mounted on a helical spring 56. Each metal cap 54 is housed within a bore hole 55 made in a cylindrical embossment 60 formed in the base 62 of the support recess 16. The shape of the cylindrical embossment 60 is configured to fit within the cylindrical cavity 27 of the screwdriver 12, and thereby position each metal cap 54 in a location which abuts the terminals 28. Each metal cap 54 includes at its base a radial flange 58 which circumferentially extends around the base edge of the cap 54. The outer diameter of the flange 58 is greater than the diameter of the bore hole 55. Therefore, when the cap 54 is in a raised condition, as shown in FIG. 5, the top surface of the flange 58 abuts an inner surface of the cylindrical embossment 60 around the bore hole 55. Spring 56 is connected to the output of the supply capacitor 42 via connectors 64. Therefore, electricity can flow through the springs 56 to rods 54. The springs 56 therefore allow the cap 54 to be depressed from a maximum raised condition (as shown in FIG. 5) to a depressed condition (an example of which is shown in FIG. 8) while still maintaining the electrical circuit between the supply capacitor 42 and the cap 54. It should be appreciated that in other embodiments, the electrical terminals 28 of the screwdriver 12 could be configured with the spring mounted arrangement of the illustrated contact rods 46 and 48 to provide similar advantages as the illustrated arrangement.

The upper surface 68 of the caps 54 are positioned at a higher height relative to the upper surface 70 of the button 50. The difference in heights are arranged to allow the terminals 28 of the screwdriver 12 to abut and engage the caps 54 before the base 26 of the screwdriver 12 contacts and thereafter activates button 50.

As best illustrated in FIG. 4, the fastener latch 18 is located proximate to the opening of support recess 16. The fastener latch 18 consists of an externally manipulable knob 66 and an internally mounted fastening rod 68. The knob 66 is a generally rectangular body which is located in a groove 67 in the upper surface 15 of the housing 14 of the charger 10. The knob 66 can be actuated by a user to move the connected fastening rod 68 within the cavity 72 in which it is mounted. The fastening rod 68 comprises a generally longitudinally aligned rod which connected to the base of the knob 66. The end proximal to the knob 66 is mounted within the cavity 72 and is engaged by a spring 74 which is seated at the internal end 76 of cavity 72. The distal end 70 of the fastening rod 68 comprises a tapered end which in an extended position, as shown in FIG. 4 projects into the support recess 16 perpendicular to the wall 17 of the support recess 16. The spring 74 biases the fastening rod 68 towards the extended position. The distal end 70 of the fastening rod 68 can be moved into a recessed position within the cavity 72 by a user moving knob 66 towards the edge 21 of the charger 10, thereby compressing spring 76.

Fastener latch 18 is used to secure and retain screwdriver 12 in position on the contact rods 46 and 48 when the screwdriver 12 is mounted within support cavity 16. As best seen in FIGS. 1 and 3, the housing 20 of screwdriver 12 includes a notch 73 into which the distal end 70 of the fastening rod 68 seats when the screwdriver 12 is inserted into support recess 16. As shown in FIG. 7, the notch 73 is positioned on the body of the screwdriver 12 which fastens the screwdriver 12 in a position within the support recess 16 in which the contact rods 46 and 48 are depressed and the button 50 is depressed, spring 52 is compressed (as shown best in FIG. 8), thereby activating charging of the screwdriver 12.

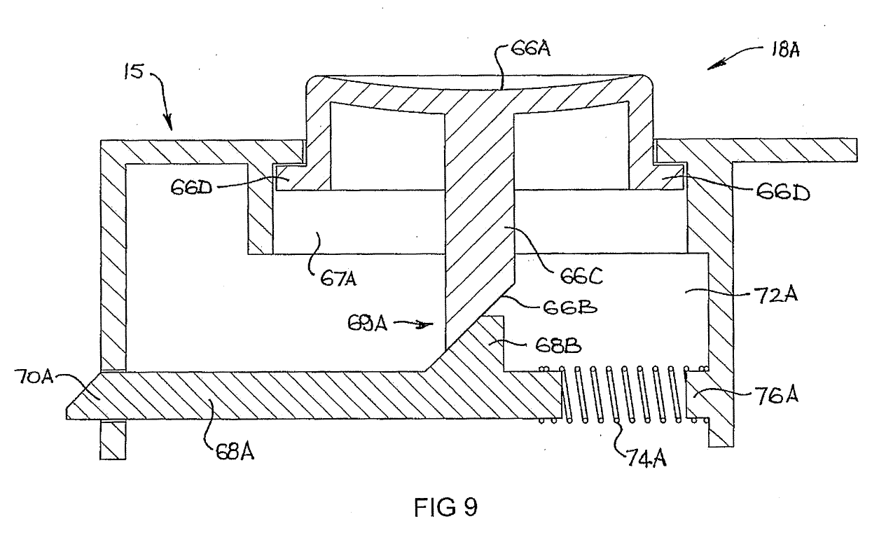

An alternative form of the fastener latch 18A used in the charger 10 is shown in FIG. 9. This form of the fastener latch 18A includes a vertically depressible button 66A which is arranged through a sliding connection 69A to move an internally mounted fastening rod 68A within cavity 72A. The button 66A consists of a generally cylindrical body located in an opening 67A in the upper surface 15 of the housing 14 of the charger 10. Button 66A is retained within opening 67A through circumferential flange 66D. The diameter of flange 66D is larger than opening 67A causing the upper surface of this flange 66D to engage on the internal wall of the housing around opening 67A when in a raised position, as shown in FIG. 9. The button 66A is biased in the raised connection through sliding connection 69A and spring 74A. The sliding connection 69A consists of two angled sections 66B and 68B. A first section of the sliding connection 69A consists of an angle section 66B is located at the base of the connection stem 66C of button 66A. The angled section is seated on and engaged with ramp 68B located at an upper surface (with reference to the orientations shown in FIG. 9) of fastening rod 68A. The fastening rod 68A has a similar configuration as the fastening rod 68 shown in FIG. 4 comprising a generally longitudinally aligned rod, having at a first end, the end proximal to the ramp 68B, a spring 74A which is seated at the internal end 76A of cavity 72A, and at a second end, the distal end 70A of the fastening rod 68A, a tapered end. The distal end 70A of the fastening rod 68A is movable between an extended position, as shown in FIG. 9, in which the distal end 70A projects into the support recess 16 perpendicular to the wall 17 of the support recess 16 and a recessed position within the cavity 72A. The spring 74A biases the fastening rod 68A towards the extended position. The distal end 70A of the fastening rod 68A can be moved into a recessed position within the cavity 72A by a user depressing button 66A, causing the angle section 66B to slide down the ramp 68B. This laterally moves the fastening rod 68A in a direction which compresses the spring 74A and retracts the end 70A into cavity 72A. Removal of the depression force on the button, causes the spring to expand, laterally moving the fastening rod 68A and forcing the distal end back into the extended position. This movement also causes the button to be raised through movement of the sliding connection 69A. This form of the fastener latch 18A allows a user to operate the latch 18A using one hand, as compared to two handed operation of the embodiment shown in FIG. 4.

While not shown in the Figs., indicator lights 19 are connected to a control circuit linked to contact rods 46 and 48. The control circuit controls the illumination of indicator lights 19 to provide an indication of the charge contained in the cylindrical storage capacitors 30 of the electric screwdriver 12.

Referring to FIG. 6, there is shown an alternative embodiment of the charger 10A which does not include a capacitor 42. Due to the similarity of configurations between this embodiment and the embodiment shown in FIG. 4, like numeral have been used to designate like parts. As a result of the absence of the supply capacitor 42 (as shown in FIG. 4), the switch 44 in this embodiment of the charger 10A, is directly connected to the power transformer 40.

Charging of the screwdriver 12 is accomplished by inserting the base 26 of the screwdriver 12 into the support recess 16 of the charger, aligning each of the terminals 28 of the screwdriver 12 with a respective contact 46 and 48. Insertion of the screwdriver 12 into the support recess 16 causes the base 26 and sidewall 29 of the housing 20 of the screwdriver 12 to engage the distal end 70 of the fastening latch 18 pushing the end 70 into a recessed position within the cavity 72. The screwdriver 12 is inserted in this aligned state until the terminals 28 abut and depress contacts 46 and 48 and button 50 is engaged and depressed by the base 26 of the screwdriver 12. In this position, the distal end 72 of latch 18 should align and be seated within notch 73, thereby locking the screwdriver 12 into a charging position within support recess 16. The screwdriver 12 is retained in the charging position within support recess 16 until the charging process is completed, as indicated by the indicator lights. Once complete, a user can move the knob 18 towards edge 21 of the housing 14 of the charger 10, unseating the distal end 70 of latch 18 from the notch 73 in the screwdriver thereby allow the screwdriver 12 to be lifted out of the support recess 16 and operated by a user.

The amount of charge contained in the screwdriver 12 at the completion of charging depends on the charging set up of the charger 10.

For example, in the embodiment of the charger 10 that includes a capacitor 42, as shown in FIG. 4, charge transfer to the capacitors 30 in the screwdriver 12 would be almost instantaneous. In this respect, the transformer 40 of charger 10 is constantly charging the supply capacitor 42. In most case, the supply capacitor 42 should be charged to full capacity. Therefore, once the screwdriver 12 is seated in recess 16 with the terminals 28 abutting the contact rods 46 and 48 and the button 50 is depressed activating the charger 10, any charge contained in the supply capacitor 42 will be almost instantly equalised throughout the supply capacitor 42 and the storage capacitors 30 of the screwdriver 12. Therefore, the storage capacitors 30 will be very rapidly recharged. As can be appreciated, the amount of recharge will depend on the relative charge capacities of the supply capacitor 42 and the storage capacitors 30. It is of course more advantageous for the charge capacity of the supply capacitor 42 to be greater than the storage capacitors 30 in order to recharge capacitors 30 to a capacity of 50% or more. For example, if the charge capacity of the supply capacitor 42 is twice the charge capacity of the storage capacitors 30, then recharging using the charger 10 will result in the capacitor being charged to 66% charge capacity. The greater the charge capacity of the supply capacitor 42 compared to the charge capacity of the storage capacitors 30, the greater the recharge.

If full charge of the supply capacitors 30 is required, the screwdriver 12 can be retained in the storage recess 16 to allow the main power supply (mains power via transformer 40) to recharge the remaining charge by a slower charge such as a high current and/or high voltage mains power charge or a low current and/or low voltage trickle charge. This manner of charging is a lot slower in comparison to the charge transfer from the supply capacitor 42.

In the embodiment of the charger 10A shown in FIG. 6, no supply capacitor 42 is included. In this embodiment, the storage capacitor 30 of the screwdriver 12 is charged directly from the mains power via transformer 40. This is a much slower charging arrangement in comparison to the charger 10 shown in FIG. 4, as charging is solely accomplished using a trickle charge.

The use of capacitors 30 as a rechargeable device provides many advantages. Firstly, in comparison a normal electrochemical type battery, capacitors are capable of absorbing energy at a rapid rate and also discharge this stored energy at a rapid rate. This allows any rechargeable device which includes capacitors to be recharged much faster in comparison to a rechargeable device which includes normal electrochemical type batteries. In addition when charging, a capacitor can be charged when at any energy capacity, whether fully discharged or partially discharged, with the capacitor adsorbing energy until it is at full capacity. When full, the capacitor stops accepting charge. In contrast, an electrochemical battery is ideally charged after it has been fully discharged so as to avoid memory effects and can be damaged if overcharged after the battery reaches full energy capacity.

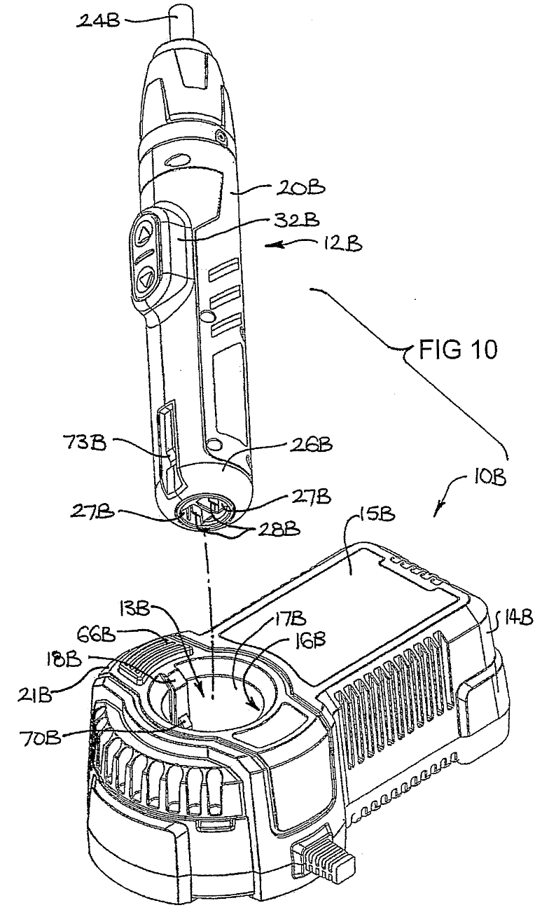

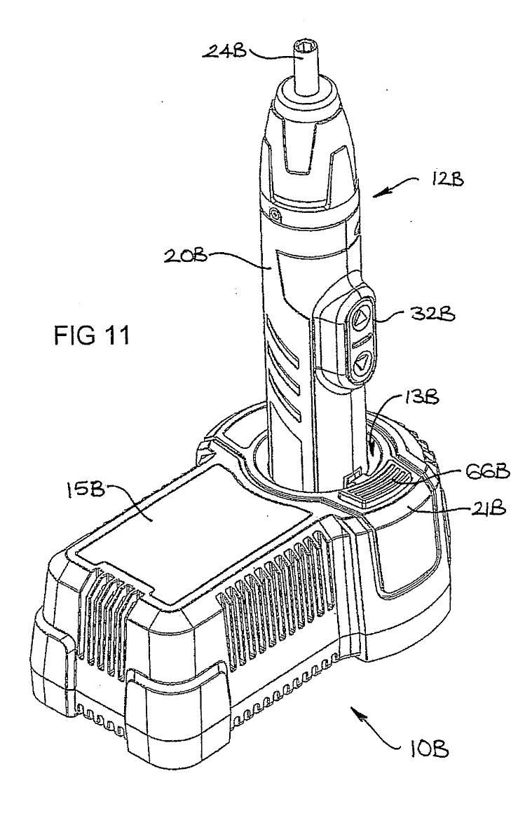

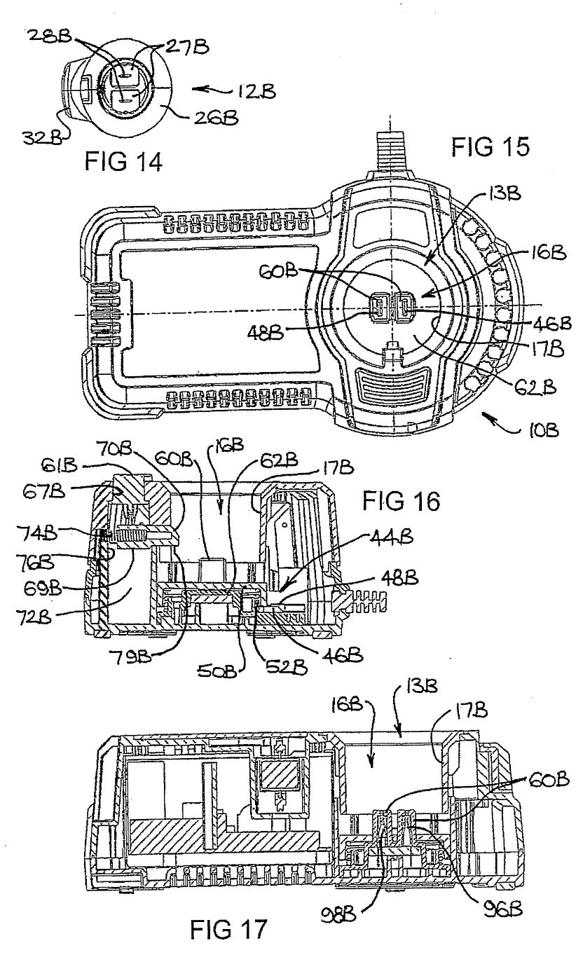

Referring to FIGS. 10 to 18, there is shown further forms of the electrical charger 10B and the rechargeable electric screwdriver 12B. The illustrated charger 10B consists of a generally rectangular box housing 14B having an upper surface 15B (relative to the orientation shown in FIGS. 10 and 11) which includes an opening 131B for a cylindrically shaped support recess 16B. The walls 17B of the support recess 16B form a receiver into which the rechargeable electric screwdriver 12B is received for charging as shown in FIG. 11. The upper surface 15B also includes a locking latch 18B, which is longitudinally movable relative to the face of the upper surface 15B.

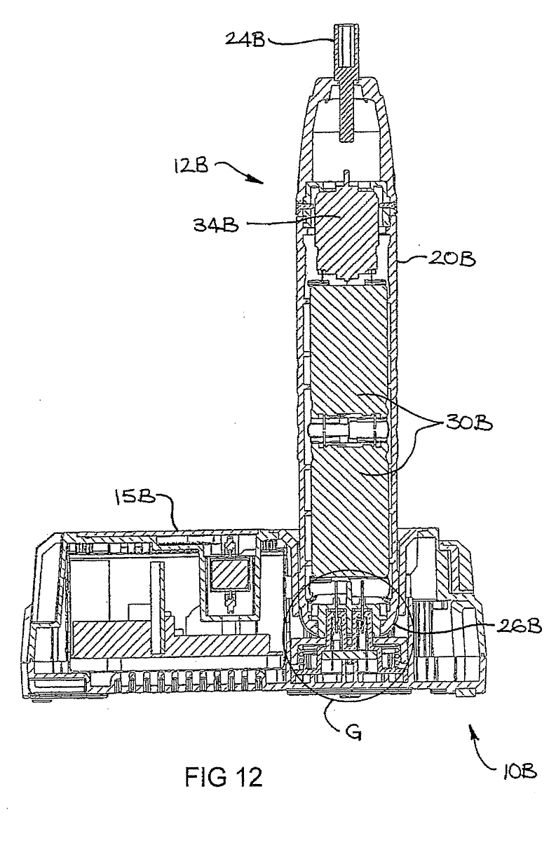

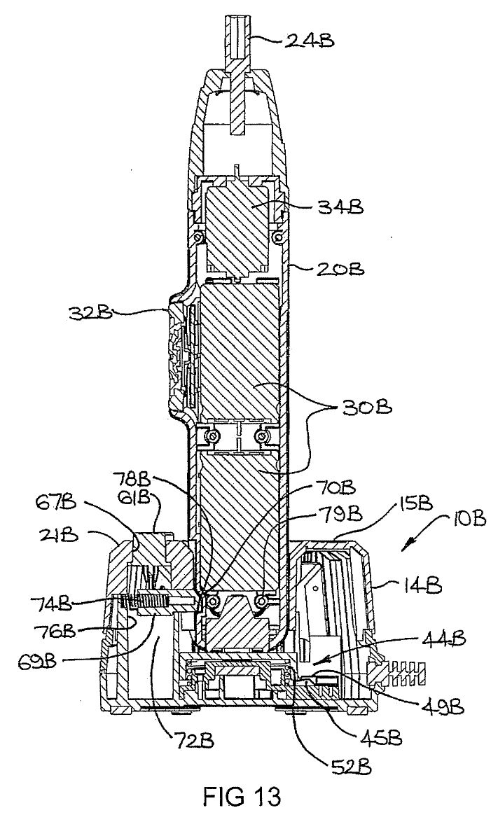

Similarly to the embodiment illustrated in FIGS. 1 to 9, the embodiment in FIGS. 10 to 18 includes a base 26B of the screwdriver 12B, electrical terminals 28B and electrical contacts 46B and 48B in the support recess 16B of the charger 10B. The screwdriver 12B has a cylindrical housing 20B including a generally domed shape base 26B which includes two spaced apart rectangular recesses 27B that enclose two electrical terminals 28B. The electrical terminals 28B connect to power storage means, which as illustrated FIGS. 12 and 13 includes two capacitors 30B. The body of the housing 20B includes an operative pivot switch 32B which when depressed operates the screwdriver 12B, causing a motor 34B to drive rotation of an output shaft 24B.

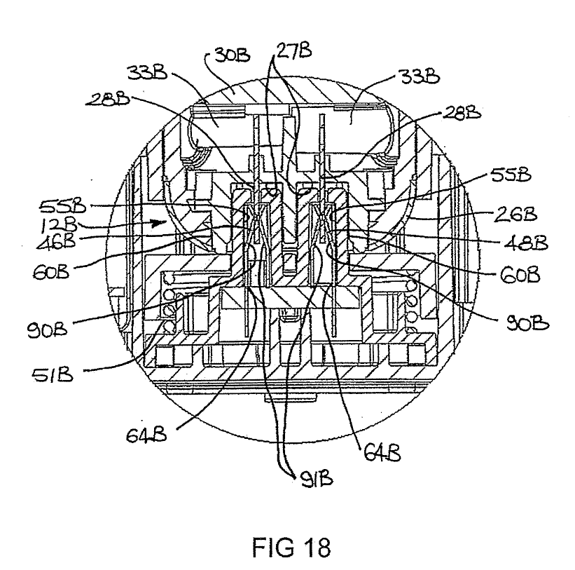

Starting at the base of the screwdriver 12B, which is illustrated in enlarged form in FIG. 18, the electrical terminals 28B enclosed by two recesses 27B in the base 26B connect to the two cylindrical storage capacitors 30B via two connecting links 33B. The electrical contacts 46B and 48B in the support recess 16B of the charger 10B are each formed out of a pair of opposing electrodes 90B, 91B enclosed within a bore hole 55B made in substantially rectangular embossments 60B formed in a base 62B of the support recess 16B. The shape of the cylindrical embossments 60B are such as to fit within the rectangular cavities 27B of the screwdriver 12B. At least one of the electrodes 90B, 91B is formed out of an elongated piece of resilient and electrically conductive material that at one end is connected to a power supply (not shown) via connectors 64B. Each electrode 90B, 91B extends upwardly from the connectors 64B and in kinked inwardly to the bore hole 55B so as to define a gap between the electrodes 90B, 91B that is less than the thickness of the electrical terminals 28B.

Thus, when the base 26B of the screwdriver 12B is inserted into the support recess 16B of the charger 10B, as illustrated in FIGS. 11 and 12, the cylindrical embossments 60B fit within the rectangular cavities 27B of the screwdriver 12B and the electrical terminals 28B are inserted into the gap between the electrodes 90B, 91B. As illustrated in FIG. 15, this deflects the electrodes 90B, 91B away from each other so as to compress the electrical terminals 28B therebetween yet allow the electrical terminals 28B to slide up and down relative to the electrodes 90B, 91B. Accordingly, the resulting relationship between the electrical terminals 28B and the electrodes 90B, 91B is of an interference fit. Thus, when the base 26B of the screwdriver 12B is inserted into the support recess 16B of the charger 10B and the electrical terminals 28B are inserted into the gap between the electrodes 90B, 91B, the screwdriver 12B can move a small distance up and down relative to the charger 10B while an electrical contact is maintained between the electrodes 90B, 91B and the electrical terminals 28B so that electricity can flow from the power supply (not shown), via the electrodes 90B, 91B and the electrical terminals 28B, to the capacitors 30B so that they may be charged. This arrangement does not require the spring loaded contacts 46 and 48 of the embodiment described above.

As shown in FIGS. 10, 11, 13, 15 and 16, the charger 10B includes a fastener latch 18B is located proximate to the opening of support recess 16B. As shown in FIG. 13, the fastener latch 18B consists of an externally manipulable knob 61B and an internally mounted fastening rod 69B. The knob 61B is a generally rectangular body which is located in a groove 67B in the upper surface 15B of the housing 14B of the charger 10B. The knob 61B can be actuated by a user to move the connected fastening rod 69B within the cavity 72B in which it is mounted. The fastening rod 69B comprises a generally longitudinally aligned rod connected to the base of the knob 61B. The end of the rod 69B, proximal to the knob 61B, is mounted within the cavity 72B and is engaged by a spring 74B which is seated at one end 76B of the cavity 72B. The distal end 70B of the fastening rod 69B is tapered, and in an extended position, as shown in FIGS. 10, 13, 15 and 17 projects into the support recess 16B perpendicular to the wall 17B of the support recess 16B. The spring 74B biases the fastening rod 69B towards the extended position. The distal end 70B of the fastening rod 69B can be moved into a recessed position within the cavity 72B by a user moving knob 61B towards edge 21B of the charger 10B, thereby compressing spring 76B.

As shown in FIGS. 10, and 13, the housing 20B of the screwdriver 12B includes a notch 73B into which the distal end 70B of the fastening rod 69B seats when the screwdriver 12B is inserted into support recess 16B. The tapering of the distal end 70B of the fastening rod 69B enables the housing 20B of screwdriver 12B to deflect the distal end 70B of the fastening rod 69B when the screwdriver 12B is inserted into support recess 16B thereby compressing the spring 76B until the distal end 70B finds the notch 73B and the spring decompresses and so as to bias the distal end 70B of the fastening rod 69B into the notch 73B corresponding to the extended position of the fastening rod 69B. The notch 73B has an upwardly oriented abutting surface 78B that abuts against a downwardly oriented abutting surface 79B at the tapered distal end 70B of the fastening rod 69B when seated in the notch 73B for preventing removal of the screwdriver 12B from the support recess 16B. When it is required to remove the screwdriver 12B from the Support recess 16B of the charger 10B, the distal end 70B of the fastening rod 69B is moved into the recessed position within the cavity 72B by a user moving knob 61B towards edge 21B of the charger 10B, thereby horizontally sliding the downwardly oriented abutting surface 79B out of abutment with the upwardly oriented abutting surface 78B of the notch 73B.

As will be appreciated, the arrangement of the electrical terminals 28B and electrical contacts 46B and 48B in the support recess 16B of the charger 10B and the arrangement of the fastener latch 18B and the notch 73B of the housing 20B of the screwdriver 12B is such that an electrical contact is established between the electrical terminals 28B and electrical contacts 46B and 48B at least when the fastener latch 18B is seated in the notch 73B.

As shown in FIGS. 13 and 16, the electrical output of the power supply 10B is connected to a depression switch 44B located in the support recess 16B of the charger 10B, which is in turn connected to the contact rods 46B and 48B. The depression switch 44B consists of a cylindrical button 50B mounted on a helical spring 52B which biases the button 50B towards a raised condition. As shown in FIG. 13, the switch 44B includes two switch contact elements 45B, 49B. The switch contact elements 45B, 49B are formed out of a resilient and conductive material. When the switch contact elements 45B, 49B are together and in contact, which corresponds with when the button 50B is in the raised condition, the switch contact elements 45B, 49B make a circuit which corresponds to an deactivated or “off” condition of the switch 44B. Accordingly, when the switch 44B is in the off position it does not supply electrical power from the power supply to the contact 46B and 48B. However, when as described above and illustrated in FIGS. 11, 12 and 13, the base 26B of the screwdriver 12B is inserted into the support recess 16B of the charger 10B, and the electrical terminals 28B are brought into contact with the contacts 46B and 48B, the base 26B of the screwdriver 12B depresses the button 50B and compresses the spring 52B. When the button 50B is depressed, as shown in FIG. 13, it deflects one of the switch contact elements 45B out of contact with the other switch contact element 49B which breaks the circuit therebetween. When the circuit is broken, this corresponds to an activated or on condition of the switch 44B. When the switch 44B is in the on position it enables electrical power to be supplied from the power supply to the contacts 46B and 48B and on to and the electrical terminals 28B of the screwdriver 12B.

When the base 26B of the screwdriver 12B is removed from the support recess 16B of the charger 10B, and the electrical terminals 28B are brought out of contact with the contact rods 46B and 48B, the depression of the button 50B is reversed and the spring 52B decompresses. This causes the switch to be placed in the deactivated “off” condition and stops power from being supplied from the power supply to the contact rods 46B and 48B.

The arrangement of the depression switch 44B, including the cylindrical button 50B, helical spring 52B, contacts 46B and 48B and the arrangement of the base 26B of the screwdriver 12B are such that when the base 26B of the screwdriver 12B is inserted into the support recess 16B of the charger 10B, and the electrical terminals 28B are brought into contact with the contact rods 46B and 48B, the depression switch 44B is placed in the activated or “on” condition only when the electrical terminals 28B are in contact with the contact rods 46B and 48B. As will be appreciated, this prevents arcing due to an inadequate contact, or no contact at all, between the electrical terminals 28B and the contacts 46B and 48B while the screwdriver 12B is mounted to the receiver for charging on the charger 10B. The arrangement is also such that the depression switch 44B is placed in the deactivated or “off” condition when the base 26B of the screwdriver 12B is removed from the support recess 16B of the charger 10B and prior to the electrical terminals 28B coming out of contact with the contact rods 46B and 48B. As will be appreciated, the form of the electrical terminals 28B and the contact rods 46B and 48B, which enables the electrical terminals 28B to slide up and down relative to the electrodes 90B, 91B of the contact rods 46B and 48B while still remaining in contact, enables some movement of the screwdriver 12B up and down relative to the charger 10B while an electrical contact is maintained between the electrical terminals 28B and the electrodes 90B, 91B of the contact rods 46B and 48B. This ensures that the depression switch 44B is placed in the deactivated or “off” condition prior to disconnection of the electrical contact between the electrical terminals 28B and the electrodes 90B, 91B of the contact rods 46B and 48B so as to avoid arcing.

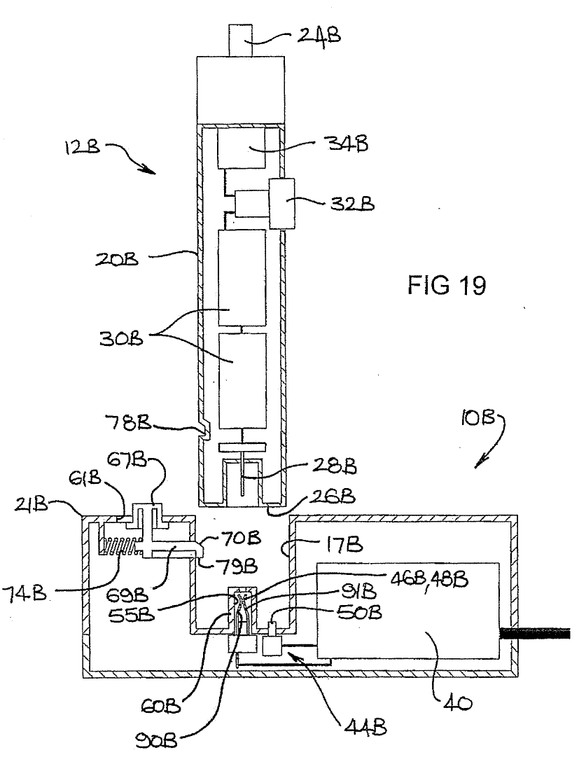

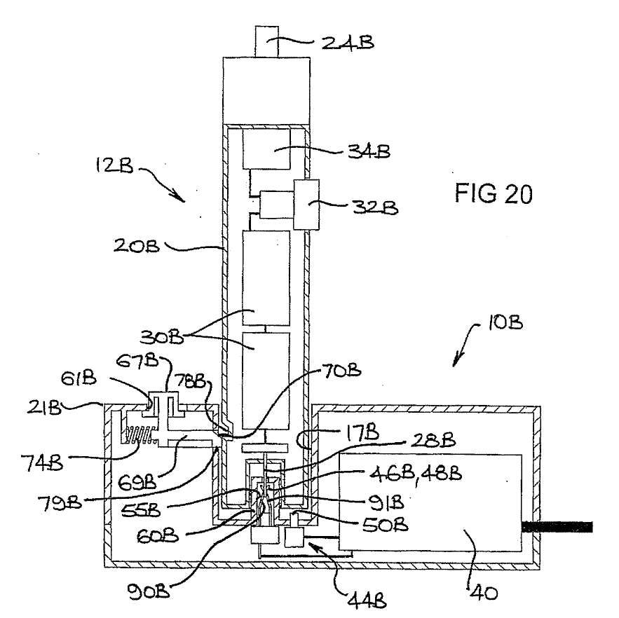

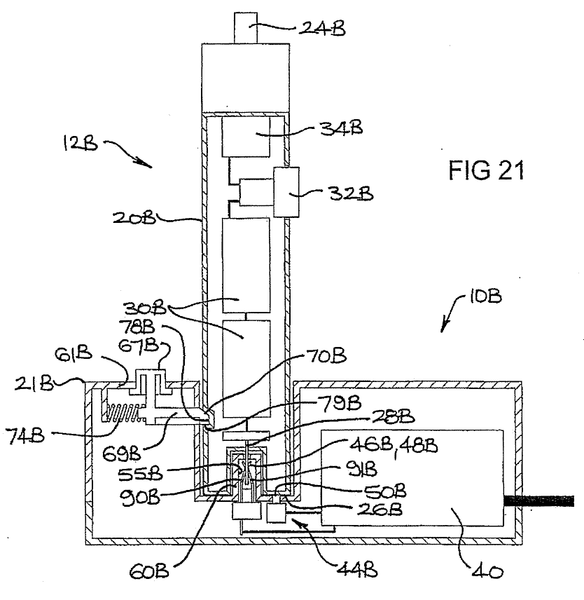

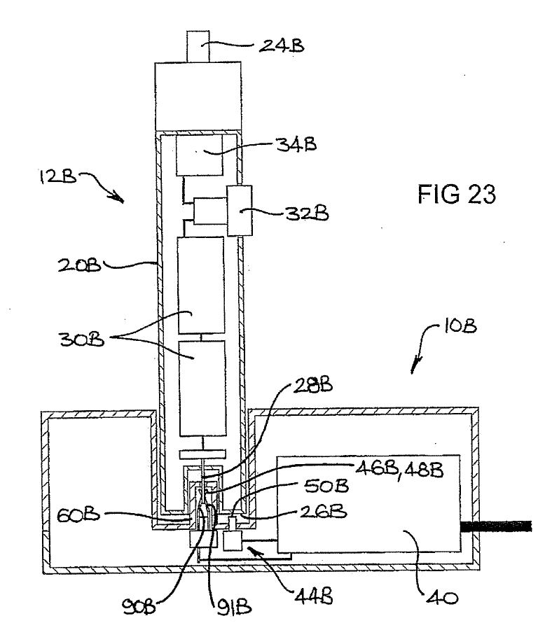

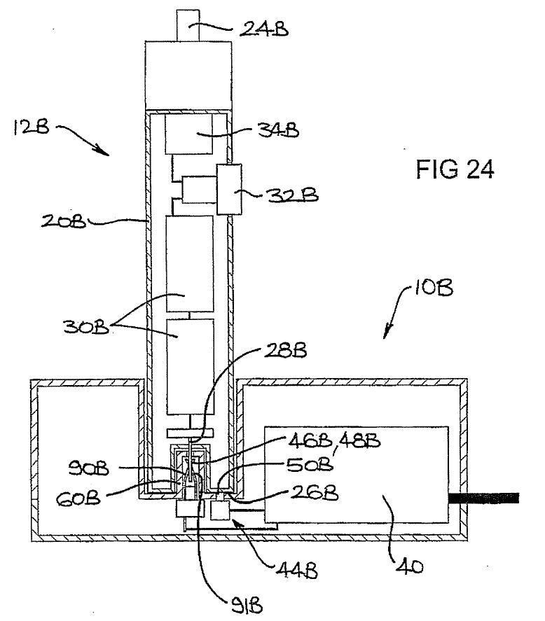

In FIGS. 19 to 24 there is shown further forms of the electrical charger 10B and the rechargeable electric screwdriver 12B. The electrical charger 10B and screwdriver 12B in FIGS. 19 to 24 are largely similar to those of FIGS. 10 to 18. However, in FIGS. 19 to 24, the electrical charger 10B incorporates an alternative form of the depression switch 44B located in the support recess 16B of the charger 10B. The depression switch 44B consists of a cylindrical button 50B mounted on a helical spring (not shown) which biases the button 50B towards a raised condition as shown in FIGS. 19, 20, 22 and 23. When in the raised condition, the switch 44B is in an off position and does not supply electrical power to the contact rods 46B and 48B. In FIG. 20 the screwdriver 12B is in the process of being inserted into the support recess 16B in order to be mounted to the electrical charger 10B and the contact rods 46B and 48B are in engagement with the corresponding electrical terminals 28B of the screwdriver 12B. In FIG. 21 the screwdriver 12B is in fully inserted into the support recess 16B and is mounted to the electrical charger 10B. The contact rods 46B and 48B are in engagement with the corresponding electrical terminals 28B of the screwdriver 12B and the cylindrical button 50B of the switch 44B is actuated by the base 26B of the screwdriver 12B to a lowered condition. When the cylindrical button 50B is in the lowered condition, the switch 44B is in an on position and supplies electrical power to the contacts 46B and 48B.

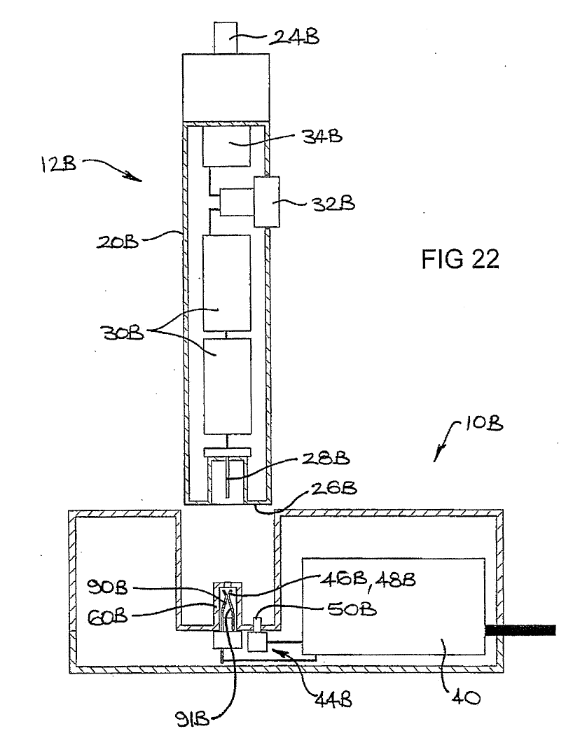

In FIGS. 22 to 24 the electrical charger 10B does not include the fastener latch 18B and the housing 20B of the screwdriver 12B does not include the complementary notch 73B. Instead, in the arrangement of FIGS. 22 to 24, the screwdriver 12B is retained at least partially by the force of gravity in the support recess 16B but also partially by the engagement of the contacts 46B and 48B of the charger 10B and the corresponding electrical terminals 28B of the screwdriver.

Instead of support recess 16B the receiver may include a plug (not shown) to which the rechargeable screwdriver 12, 12B is mountable. The plug may also include the at least one electrical contact 46, 46B, 48, 48B, the switch 44, 44B as well as means for engaging and retaining the rechargeable screwdriver 12, 12B mounted to the plug. A flexible electrically conductive lead would connect the at least one electrical contact 46, 46B, 48, 48B situated on the plug with the power supply.

It should be appreciated that the described charger 10, 10B could be used to charge other types of rechargeable power devices other than the rechargeable screwdriver 12, 12B. Many other types of power tools such as rechargeable drills, sanders, planers, portable lights, power saws, chainsaws, routers, lathes, grinders, polishers, rotary tools, or the like could utilise a similar charging configuration in which the rechargeable devices could be configured to be fastened within a support cavity similar to that described to charge that rechargeable device.

Those skilled in the art will appreciate that the invention described herein is susceptible to variations and modifications other than those specifically described. It is understood that the invention includes all such variations and modifications which fall within the spirit and scope.

Throughout the description and claims of the specification the word “comprise” and variations of the word, such as “comprising” and “comprises”, is not intended to exclude other additives, components, integers or steps.

Future patent applications may be filed in Australia or overseas on the basis of or claiming priority from the present application. It is to be understood that the following provisional claims are provided by way of example only, and are not intended to limit the scope of what may be claimed in any such future application. Features may be added to or omitted from the provisional claims at a later date so as to further define or re-define the invention or inventions.

1. An electrical charger for charging a rechargeable electrical device, the rechargeable electrical device including at least one storage ultracapacitor, the charger including:
a receiver for receiving the rechargeable electrical device;
at least one electrical contact through which power can be supplied to the rechargeable electrical device, the electrical contacts being arranged to engage corresponding electrical terminals of the rechargeable electrical device when the rechargeable electrical device is mounted to the receiver; and
characterised by at least one supply ultracapacitor electrically connected to the at least one electrical contact, the supply ultracapacitor being charged when the electrical charger is connected to a power source;
wherein, in use, any charge in the supply ultracapacitor is rapidly distributed between the supply ultracapacitor and storage ultracapacitor when the rechargeable electrical device is mounted to the receiver thereby providing a rapid charge to the rechargeable electrical device.

2. The electrical charger according to claim 1, wherein the energy capacity of the supply ultracapacitor is greater than the energy capacity of the storage ultracapacitor.

3. The electrical charger according to claim 1, wherein the energy capacity of the supply ultracapacitor is more than twice the energy capacity of the storage ultracapacitor.

4. The electrical charger according to claim 1, further including a switch for controlling a supply of power to the at least one electrical contact wherein the switch is arranged to be actuated to supply power to the at least one electrical contact after the electrical terminals engage the at least one electrical contact and to be actuated to terminate supply of power to the at least one electrical contact before the electrical terminals disengage from the at least one electrical contact.

5. The electrical charger according to claim 4, wherein the switch is actuable relative to an activated position, the activated position corresponding to when power is supplied to the at least one electrical contact, wherein the switch is actuated to the activated position when the rechargeable device is mounted to the receiver and is actuated from the activated position when the rechargeable device is removed from the receiver.

6. The electrical charger according to claim 1, wherein the receiver includes a plug to which the rechargeable electrical device is mountable and the at least one electrical contact is situated on the plug, the plug includes means for engaging and retaining the rechargeable electrical device mounted to the plug and a flexible electrically conductive lead connecting the at least one electrical contact situated on the plug with the supply ultracapacitor.

7. The electrical charger according to claim 1, wherein the at least one supply ultracapacitor and the at least one storage ultracapacitor includes any one or more of the group including supercapacitors, ultracapacitors, psuedocapacitors and hybrid capacitors.

8. The electrical charger according to claim 7, further including means for indicating the charge in the rechargeable device.

9. The electrical charger according to claim 1, wherein the receiver includes a plug to which the rechargeable electrical device is mountable and the at least one electrical contact is situated on the plug, the plug includes means for engaging and retaining the rechargeable electrical device mounted to the plug and a flexible electrically conductive lead connecting the at least one electrical contact situated on the plug with the supply ultracapacitor and the switch is situated on the plug.

10. The electrical charger according to claim 1, wherein the at least one electrical contact is movable relative to the corresponding electrical terminals of the rechargeable device while in engagement with the corresponding electrical terminals.

11. The electrical charger according to claim 1, wherein the at least one electrical contact includes a pair of opposing electrodes that define a gap for receiving, in an interference fit, the corresponding electrical terminals of the rechargeable device therebetween.

12. The electrical charger according to claim 1, wherein the at least one electrical contact is movable relative to the receiver while maintaining contact with the corresponding electrical terminals of the rechargeable device.

13. The electrical charger according to claim 1, wherein the at least one electrical contact is spring loaded.

14. The electrical charger according to claim 1, wherein either the electrical contact or the electrical terminal or both includes at least one electrical conducting member mounted on at least one resilient element.

15. The electrical charger according to claim 1, further including a fastening arrangement for fastening the rechargeable device to the receiver when the rechargeable device is mounted to the receiver.

16. The electrical charger according to claim 1, wherein the receiver includes a recess into which the rechargeable device is insertable and the at least one electrical contact is situated at a base of the recess.

17. The electrical charger according to claim 1, wherein the electrical device includes an electromechanical device.

18. The electrical charger according to claim 1, wherein the electrical device is a power tool.

19. The electrical charger according to claim 1, wherein the electrical device is an appliance such as a kitchen, household or personal care electrical appliance.

20. The electrical charger according to claim 1, wherein the rechargeable device is an energy storage pack for use with a powered device.

21. The electrical charger according to claim 1, wherein the rechargeable device is a rechargeable screwdriver.

22. The electrical charger according to claim 1, further including means for indicating the charge in the rechargeable device.

23. An electrical charger for charging a rechargeable device including at least one storage ultracapacitor for storing power, the electrical charger including:
a receiver to which the rechargeable device is mountable;
at least one electrical contact through which power can be supplied to the rechargeable device, the electrical contacts being arranged to engage corresponding electrical terminals of the rechargeable device when the rechargeable device is mounted to the receiver; and
a switch for controlling a supply of power to the at least one electrical contact, the switch being actuated when the device is mounted or dismounted from the receiver;
wherein the switch is arranged with the receiver to be actuated to supply power to the at least one electrical contact after the electrical terminals of the rechargeable device have engaged the at least one electrical contact and to be actuated to terminate supply of power to the at least one electrical contact before the electrical terminals of the rechargeable device have disengaged from the at least one electrical contact.

24. The electrical charger according to claim 23, wherein the at least one storage ultracapacitor includes any one or more of the group including supercapacitors, ultracapacitors, psuedocapacitors and hybrid capacitors.

25. The electrical charger according to claim 23, further including at least one supply ultracapacitor electrically connected to the at least one electrical contact, the supply ultracapacitor being chargable when the electrical charger is connected to a power source.

26. The electrical charger according to claim 25, wherein the at least one supply ultracapacitor includes any one or more of the group including supercapacitors, ultracapacitors, psuedocapacitors and hybrid capacitors.

27. The electrical charger according to claim 25, wherein the energy capacity of the supply ultracapacitor is more than twice the energy capacity of the storage ultracapacitor

28. The electrical charger according to claim 23, wherein the switch is actuable relative to an activated position, the activated position corresponding to when power is supplied to the at least one electrical contact, wherein the switch is actuated to the activated position when the rechargeable device is mounted in the receiver and is actuated from the activated position when the rechargeable device is removed from the receiver.

29. The electrical charger according to claim 23, wherein the switch includes a biasing means for biasing the switch from the activated position.

30. The electrical charger according to claim 23, wherein the receiver includes a plug to which the rechargeable electrical device is mountable and the at least one electrical contact is situated on the plug, the plug includes means for engaging and retaining the rechargeable electrical device mounted to the plug and a flexible electrically conductive lead connecting the at least one electrical contact situated on the plug with the supply ultracapacitor and the switch is situated on the plug.

31. The electrical charger according to claim 23, wherein the at least one electrical contact is movable relative to the corresponding electrical terminals of the rechargeable device while in engagement with the corresponding electrical terminals.

32. The electrical charger according to claim 23, wherein the at least one electrical contact includes a pair of opposing electrodes that define a gap for receiving, in an interference fit, the corresponding electrical terminals of the rechargeable device therebetween.

33. The electrical charger according to claim 23, wherein the at least one electrical contact is movable relative to the receiver while maintaining contact with the corresponding electrical terminals of the rechargeable device.

34. The electrical charger according to claim 23, wherein the at least one electrical contact is spring loaded.

35. The electrical charger according to claim 23, wherein either the electrical contact or the electrical terminal or both includes at least one electrical conducting member mounted on at least one resilient element.

36. The electrical charger according to claim 23, further including a fastening arrangement for fastening the rechargeable device to the receiver when the rechargeable device is mounted to the receiver.

37. The electrical charger according to claim 23, wherein the receiver includes a recess into which the rechargeable device is insertable and the at least one electrical contact is situated at a base of the recess.

38. The electrical charger according to claim 23, wherein the electrical device includes an electromechanical device.

39. The electrical charger according to claim 23, wherein the electrical device is a power tool.

40. The electrical charger according to claim 23, wherein the electrical device is an appliance such as a kitchen, household or personal care electrical appliance.

41. The electrical charger according to claim 23, wherein the rechargeable device is an energy storage pack for use with a powered device.

42. The electrical charger according to claim 23, wherein the rechargeable device is a rechargeable screwdriver.

43. A rechargeable power tool capable of being rapidly charged by a charger, the rechargeable power tool including:
a housing;
an operative portion, movable relative to the housing;
a drive means including a motor being operable to move the operative portion relative to the housing;
at least one power storage ultracapacitor for powering the drive means;
one or more electrical terminals electrically connected to the ultracapacitor arranged to engage corresponding electrical contacts of an electrical charger for charging the ultracapacitor; and
wherein the power storage ultracapacitor alone powers the drive means.

44. The rechargeable power tool according to claim 43, wherein the motor and the at least one power storage ultracapacitor are located internally within the housing of the power tool.

45. The rechargeable power tool according to claim 43, wherein the housing includes a base enclosing the electrical terminals and being adapted to be mounted to an electrical charger to engage the corresponding electrical contacts of the electrical charger an thereby charge the ultracapacitor.

46. The rechargeable power tool according to claim 43, wherein the at least one ultracapacitor includes any one or more of the group consisting of supercapacitors, ultracapacitors, psuedocapacitors and hybrid capacitors.

47. The rechargeable power tool according to claim 43, wherein the operative portion includes a fastening assembly for holding an operative element, the fastening assembly being rotatable about an operative axis by the drive means.

48. The rechargeable power tool according to claim 43, further including a gearing arrangement between the drive means and the operative portion.

49. A combination of a rechargeable power tool according to claim 43, and an electrical charger according to claim 8.

50. The rechargeable power tool according to claim 43, wherein the power tool is a rechargeable screwdriver.

51. The rechargeable power tool according to claim 43, wherein the power tool is an electromechanical appliance.

52. The rechargeable power tool according to claim 43, wherein the power tool is a kitchen, household or personal care electrical appliance.

53. A rechargeable energy storage pack for use with an electrically powered device, the rechargeable energy storage pack including:
a housing adapted to couple with an electrically powered device and with an electrical charger;
one or more electrical terminals arranged to engage a corresponding electrical contact of an electrical charger and a corresponding electrical contact of the device;
at least one ultracapacitor disposed within the housing and coupled to the one or more electrical terminals, whereby the ultracapacitor is charged by power received from the electrical charger and the device receives the power from the ultracapacitor through the one or more electrical terminals.

54. The rechargeable electrical power storage pack according to claim 53, wherein the at least one ultracapacitor includes any one or more of the group consisting of supercapacitors, ultracapacitors, psuedocapacitors and hybrid capacitors.

55. The rechargeable electrical power storage pack according to claim 53, wherein the power storage pack is adapted to be charged using an electrical charger according to claim 1 or claim 6.
